(19) United States
(12) Patent Application Publication
(10) Pub. No.: US 2007/0121263 A1
(43) Pub. Date: May 31, 2007

(54) TIMING CONTROLLER CHIP

(76) Inventors: Jeng-Shu Liu, Hsinchu County (TW); Jen-Ta Yang, Taipei County (TW); Chien-Cheng Tu, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/307,045

(22) Filed: Jan. 20, 2006

(30) Foreign Application Priority Data
Nov. 29, 2005 (TW) 94141851

(51) Int. Cl. H02H 9/00

(52) U.S. Cl. 361/56

(57) ABSTRACT

A timing controller chip including a first resistor, a second resistor, a first electrostatic discharge (ESD) protection circuit, a second ESD protection circuit, and an operational amplifier is provided. Wherein, the first and the second resistors are electrically coupled to a first and a second low voltage differential signal (LVDS) input pins of the timing controller chip, respectively. The first and the second ESD protection circuits are electrically coupled to the first and the second resistors, respectively. Moreover, the operational amplifier has a non-inverting input terminal electrically coupled to the first resistor and the first ESD protection circuit, and an inverting input terminal is electrically coupled to the second resistor and the second ESD protection circuit.

### CROSS-REFERENCE TO RELATED APPLICATION

This application claims the priority benefit of Taiwan application serial no. 94141851, filed on Nov. 29, 2005. All disclosure of the Taiwan application is incorporated herein by reference.

### BACKGROUND OF THE INVENTION

1. Field of the Invention

The present invention relates to a timing controller chip, and more particularly, to a timing controller chip with an electrical overstress (EOS) protection function.

2. Description of the Related Art

The timing controller is a major component in the driving circuit of the liquid crystal display (LCD) panel for providing the control signals to the source driver and the gate driver so as to correctly display the frame. Currently, the timing controller is usually assembled in a single chip, thus it is also known as a timing controller chip.

During the testing procedure of the printed circuit board (hereinafter “PCB”) in the fabricating process of the LCD panel, it is common that the low voltage differential signal (LVDS) input pins of the timing controller chip will be damaged by the EOS, resulting in permanent malfunction.

FIG. 1 schematically shows a circuit diagram of an LVDS input pin circuit 100 in a conventional timing controller chip. The chip is fabricated by a 0.18 μm 1.8V/3.3V 1 poly (poly-silicon) 5 metal logic process. The LVDS input pin circuit 100 comprises two electrostatic discharge (ESD) protection circuits ESD1 and ESD2, and an operational amplifier OP, wherein each of the ESD circuits ESD1 and ESD2 is constituted by an n-channel metal oxide semiconductor field effect transistor (NMOS transistor). In addition, the output terminal o of the operational amplifier OP is electrically linked to an internal circuit of the timing controller chip.

The current vs. voltage relationship of the LVDS input pin circuit 100 is shown in FIG. 2. Specifically, FIG. 2 shows a current vs. voltage diagram of the LVDS input pin INP or INN opposite to the ground. The measured value on the input pin INP is exactly the same as the measured value on the input pin INN, thus only one diagram is required. As shown in FIG. 2, the LVDS input pin circuit 100 can only endure an EOS of 7V. In other words, during the PCB testing process, as long as a surge higher than 7V is input to either the INP or INN, the transistors inside the corresponding ESD protection circuits and inside the operational amplifier OP are collapsed, which permanently damages the timing controller chip.

Since it is hard to ensure the EOS protection is perfectly performed on all of the testing tools and production environments distributed all over the world, if the EOS protection technique can be integrated into the chip, the poor yield rate in the assembly line and the manufacturing cost will be significantly reduced. Currently, there are two techniques to integrate the EOS protection into the timing controller chip, but both of them have the drawbacks.

The first technique uses a high-voltage enduring process. For example, more steps, such as increasing the thickness of the gate oxide and the low density ion doping to cover the transistor, are added in the fabricating process to raise the breakdown voltage of the transistor. Such technique complicates the fabricating process and increases the manufacturing cost. Moreover, the electrical property of the high-voltage enduring process is different from that of the logic process, thus the circuit has to be greatly modified.

The second technique uses a serial-connected ESD protection circuit. Such technique increases the layout area and reduces the capability of ESD protection. Although such technique can protect the ESD protection circuit, it cannot protect the transistors inside the operational amplifier OP.

### SUMMARY OF THE INVENTION

Therefore, it is an object of the present invention to provide a timing controller chip. The timing controller chip provided by the present invention significantly reduces the poor yield rate in the assembly line and decreases the manufacturing cost by integrating the EOS protection technique to improve the EOS endurance. The timing controller chip with the original ESD protection capability is fabricated from the original fabricating process, such that the present invention can provide the EOS protection to both of the ESD protection circuit and the operational amplifier.

In order to achieve the object mentioned above and others, the present invention provides a timing controller chip. The timing controller chip comprises a first resistor, a second resistor, a first electrostatic discharge (ESD) protection circuit, a second ESD protection circuit, and an operational amplifier. Wherein, the first and the second resistors are electrically coupled to a first and a second low voltage differential signal (LVDS) input pins of the timing controller chip, respectively. The first and the second ESD protection circuits are electrically coupled to the first and the second resistors, respectively. Moreover, the operational amplifier has a non-inverting input terminal electrically coupled to the first resistor and the first ESD protection circuit, and an inverting input terminal is electrically coupled to the second resistor and the second ESD protection circuit.

In the timing controller chip according to an embodiment of the present invention, both of the first and second transistors are poly-silicon transistors. For example, they are n-channel poly-silicon transistors or p-channel poly-silicon transistors.

By integrating the EOS protection technique to improve the EOS endurance, the timing controller chip of the present invention significantly reduces the poor yield rate in the assembly line and greatly decreases the manufacturing cost without having to modify the equipment and flow of the assembly line. In the present invention, the timing controller chip mentioned above is slightly modified to add two additional resistors. With such new design, the original fabricating process can be used and the original ESD protection capability can be maintained. Accordingly, as described in the preferred embodiment of the present invention, the present invention can provide the EOS protection to both of the ESD protection circuit and the operational amplifier.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a circuit diagram of an LVDS input pin circuit in a conventional timing controller chip.

FIG. 2 schematically shows a current vs. voltage diagram of the LVDS input pin opposite to the ground in a conventional timing controller chip.

FIG. 3 schematically shows a circuit diagram of an LVDS input pin circuit in a timing controller chip according to a preferred embodiment of the present invention.

FIG. 4 schematically shows a current vs. voltage diagram of the LVDS input pin opposite to the ground in a timing controller chip according to the preferred embodiment of the present invention.

FIG. 5 schematically shows a circuit diagram of the operational amplifier in FIG. 3.

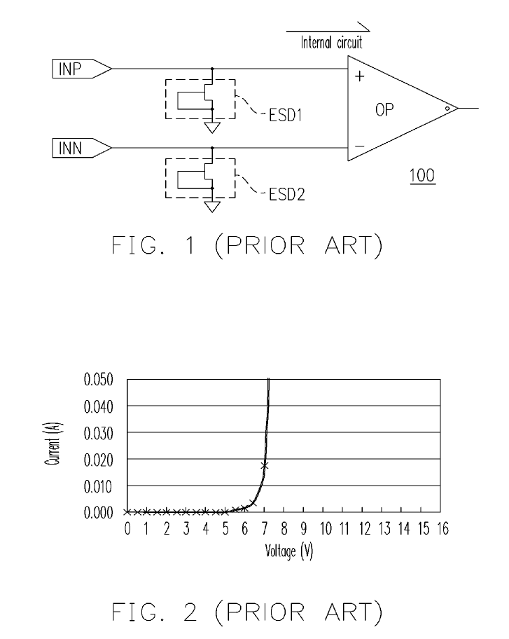

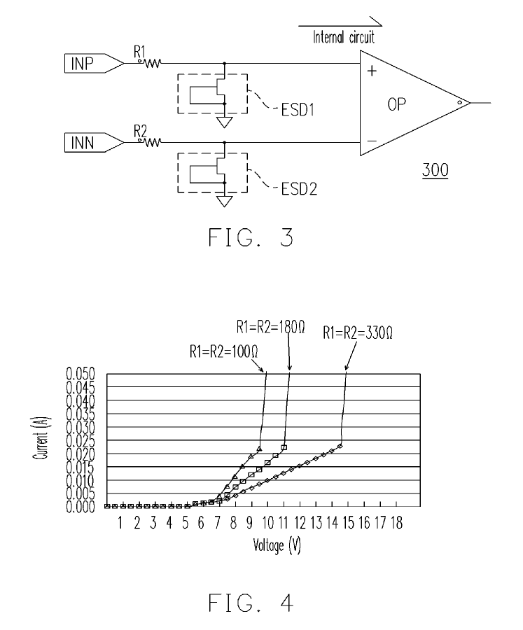

### DESCRIPTION OF THE PREFERRED EMBODIMENTS

FIG. 3 schematically shows a circuit diagram of an LVDS input pin circuit 300 in a timing controller chip according to a preferred embodiment of the present invention. The LVDS input pin circuit 300 comprises two resistors R1 and R2, two ESD protection circuits ESD1 and ESD2, and an operational amplifier OP. Wherein, the resistor R1 is electrically coupled to an LVDS input pin INP of the timing controller chip. The resistor R2 is electrically coupled to the other LVDS input pin INN of the timing controller chip. The ESD protection circuit ESD1 is electrically coupled to the resistor R1, and the ESD protection circuit ESD2 is electrically coupled to the resistor R2. A non-inverting input terminal (marked as “+”) of the operational amplifier OP is electrically coupled to the resistor R1 and the ESD protection circuit ESDI, and an inverting input terminal (marked as “−”) is electrically coupled to the second resistor R2 and the ESD protection circuit ESD2. Moreover, an output terminal of the operational amplifier is linked to an internal circuit of the timing controller chip.

Both of the resistors R1 and R2 in the present embodiment are poly-silicon resistors. For example, they are n-channel or p-channel poly-silicon transistors. Each of the ESD protection circuits ESD1 and ESD2 is constituted by an NMOS transistor, wherein a gate of each NMOS transistor is electrically coupled to a source of the NMOS transistor. The present invention does not limit the type of the ESD protection circuit, thus in other embodiments of the present invention, the ESD protection circuits EDS1 and ESD2 can be replaced with any type of existing ESD protection circuit. Moreover, the present invention does not limit the type of the operational amplifier, thus in other embodiment of the present invention, the operational amplifier OP can be replaced with any type of existing operational amplifier.

Comparing to the conventional configuration, only two additional resistors are added in the LVDS input pin circuit 300 of the present embodiment. Accordingly, the timing controller chip can be fabricated by the original fabricating process, for example, the 0.18 μm 1.8V/3.3V 1 poly (poly-silicon) 5 metal logic process mentioned above.

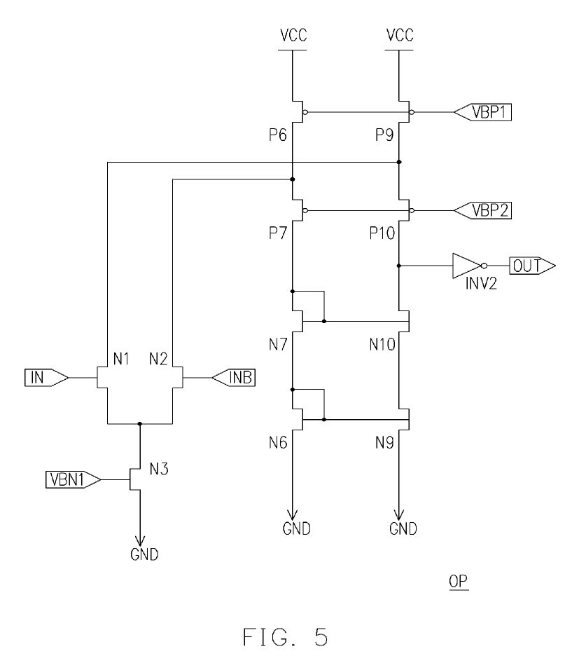

FIG. 4 schematically shows a current vs. voltage diagram of the LVDS input pin INP or INN opposite to the ground in FIG. 3. The measured value on the input pin INP is exactly the same as the measured value on the input pin INN, thus only one diagram is required. As shown in FIG. 4, the EOS endurance of the LVDS input pin circuit 300 is enhanced to 9.5V when R1=R2=100 ohm, enhanced to 11V when R1=R2=180 ohm, and enhanced to 14.5V when R1=R2=300 ohm. By appropriately controlling the resistances of the transistors R1 and R2, the EOS endurance is improved, which alleviates the EOS damage on the LVDS input pin in the timing controller chip during the PCB testing process.

FIG. 5 schematically shows a circuit diagram of an operational amplifier in FIG. 3. The operational amplifier OP comprises a plurality of NMOS transistors N1, N2, N3, N6, N7, N9, N10, a plurality of PMOS transistors P6, P7, P9, P10, and an inverter INV2. Wherein, the input terminal IN of FIG. 5 is exactly the non-inverting input terminal “+” of FIG. 3, the input terminal INB of FIG. 5 is exactly the inverting input terminal “−” of FIG. 3, and the output terminal OUT of FIG. 5 is exactly the output terminal “o” of FIG. 3. Here, the output terminal “o” is electrically connected to the internal circuit of the timing controller chip. The NMOS transistors N1 and N2 in the internal circuit of the operational amplifier OP and the ESD protection circuits ESD1 and ESD2 are the components which may be damaged by the EOS.

In summary, by integrating the EOS protection technique to improve the EOS endurance, the timing controller chip of the present invention significantly reduces the poor yield rate in the assembly line and greatly decreases the manufacturing cost without having to modify the equipment and flow of the assembly line. In the present invention, the timing controller chip mentioned above is slightly modified to add two additional resistors. With such new design, the original fabricating process can be used and the original ESD protection capability can be maintained. Accordingly, the present invention can provide the EOS protection to both of the ESD protection circuit and the operational amplifier.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. A timing controller chip, comprising:
a first resistor electrically coupled to a first low voltage differential signal (LVDS) input pin of the timing controller chip;
a second resistor electrically coupled to a second low voltage differential signal (LVDS) input pin of the timing controller chip;
a first electrostatic discharge (ESD) protection circuit electrically coupled to the first resistor;
a second electrostatic discharge (ESD) protection circuit electrically coupled to the second resistor; and
an operational amplifier having a non-inverting input terminal electrically coupled to the first resistor and the first ESD protection circuit, and an inverting input terminal electrically coupled to the second resistor and the second ESD protection circuit.

2. The timing controller chip of claim 1, wherein both of the first resistor and the second resistor are poly-silicon resistors.

3. The timing controller chip of claim 2, wherein both of the first resistor and the second resistor are n-channel poly-silicon resistors.

4. The timing controller chip of claim 2, wherein both of the first resistor and the second resistor are p-channel poly-silicon resistors.

5. The timing controller chip of claim 1, wherein the first ESD protection circuit comprises a first NMOS transistor, and the second ESD protection circuit comprises a second NMOS transistor.

6. The timing controller chip of claim 5, wherein a gate of the first NMOS transistor is electrically coupled to a source of the first NMOS transistor, and a gate of the second NMOS transistor is electrically coupled to a source of the second NMOS transistor.

7. A timing controller chip, comprising:
a first resistor electrically coupled to a first low voltage differential signal (LVDS) input pin of the timing controller chip;
a second resistor electrically coupled to a second low voltage differential signal (LVDS) input pin of the timing controller chip; and
an operational amplifier having a non-inverting input terminal electrically coupled to the first resistor, and an inverting input terminal electrically coupled to the second resistor.

8. The timing controller chip of claim 7, wherein both of the first resistor and the second resistor are poly-silicon resistors.

9. The timing controller chip of claim 8, wherein both of the first resistor and the second resistor are n-channel poly-silicon resistors.

10. The timing controller chip of claim 8, wherein both of the first resistor and the second resistor are p-channel poly-silicon resistors.

11. The timing controller chip of claim 7, further comprising:
a first ESD protection circuit electrically coupled to the first resistor and the non-inverting input terminal of the operational amplifier; and
a second ESD protection circuit electrically coupled to the second resistor and the inverting input terminal of the operational amplifier.

12. The timing controller chip of claim 11, wherein the first ESD protection circuit comprises a first NMOS transistor, and the second ESD protection circuit comprises a second NMOS transistor.

13. The timing controller chip of claim 12, wherein a gate of the first NMOS transistor is electrically coupled to a source of the first NMOS transistor, and a gate of the second NMOS transistor is electrically coupled to a source of the second NMOS transistor.
